(19) United States
(12) Patent Application Publication
(10) Pub. No.: US 2015/0295454 A1
(43) Pub. Date: Oct. 15, 2015

(54) INDUCTION MACHINE WITH DUAL PHASE MAGNETIC MATERIAL FOR SENSORLESS CONTROL

(71) Applicant: GENERAL ELECTRIC COMPANY, SCHENECTADY, NY (US)

(72) Inventors: Ayman Mohamed Fawzi EL-Refaie, Niskayuna, NY (US); Kum-Kang Huh, Niskayuna, NY (US)

(73) Assignee: GENERAL ELECTRIC COMPANY, SCHENECTADY, NY (US)

(21) Appl. No.: 14/252,893

(22) Filed: Apr. 15, 2014

(51) Int. Cl. H02K 1/02; H02K 17/02; H02K 1/26

(52) U.S. Cl. CPC H02K 1/02; H02K 1/26; H02K 17/02

(57) ABSTRACT

A rotor lamination that is made of a circular laminar element that has multiple rotor bar openings displaced circumferentially around the element and is made of a magnetic material, such as a dual-phase or bi-state magnetic material. A region of the element has received a treatment, thereby rendering the region so that the relative magnetic permeability of the treated region is less than that of the magnetic material. A rotor core assembly and induction machine that incorporates the rotor lamination and method of manufacture of the rotor lamination are also disclosed.

### BACKGROUND

The present invention relates generally to the electrical machines such as induction machines and, more particularly, to an induction machine with dual phase magnetic material that enables sensorless control, a component thereof, and methods of manufacture.

The usage of electrical machines in various industries continues to become more prevalent in numerous industrial, commercial, and transportation industries. With, for example, hybrid and/or electrical vehicle traction applications, use of induction machines is fairly prevalent. There is a challenge with high power density and high efficiency requirements with these applications. There is also a tradeoff between power density, efficiency, and the electrical machine's constant power speed range that present design challenges.

One challenge is addressed by the elimination of rotor shaft transducers such as rotor position and/or speed sensors which is desirable so as to reduce cost and/or overall motor package sizing and improve system reliability. Shaft transducers are a major source of failure and cost in electrical machine drives.

Introducing saliency to the rotor construct (e.g., rotor lamination) is a typical goal to enable the omission of sensors. There are typically two ways to introduce saliency: modulating leakage (induction) of the rotor bars and/or modulating the high-frequency rotor bar resistance. Leakage modulation may be obtained by a combination of ways, including: varying the thickness (or width) of the bridge region in the lamination; and/or, (in the case with slotted openings) varying the slot opening width. Resistance modulation may be obtained by adjusting the cross-sectional shape and/or area of the rotor bar. Varying the shape and/or area, which may include varying the width and/or height, of the rotor bar effects resistance modulation.

FIGS. 1 and 2 depict but two examples of rotor lamination designs of the related art that attempt to introduce saliency. FIG. 1, for example, shows a rotor lamination that has uniform-sized rotor openings, wherein each opening has an open-slot configuration. FIG. 2, for example, shows a rotor lamination that has rotor openings that are not all of uniform shape and size. As depicted, some of the rotor openings are of the closed variety, while other rotor openings have an open-slot configuration. Additionally, the slotted rotor openings have a larger cross-sectional area than the closed slot variety. Clearly, other embodiments, not shown, are also known.

In any event, the introduction of saliency in these embodiments present challenges in terms of manufacturing of the laminations, and the rotor itself Ultimately, these methodologies present challenges in terms of manufacture, cost, and quality control of the rotor lamination and ensuing rotor structure.

Accordingly, there is an ongoing need for to improve upon existing electrical machine technologies.

### BRIEF DESCRIPTION

The present invention addresses at least some of the aforementioned challenges by providing an electrical machine that ultimately allows for sensorless control. More specifically, the present invention is directed to provide a rotor lamination, an induction machine with dual phase magnetic material that allows for sensorless control that uses the rotor lamination, and a method of manufacture.

Therefore, in accordance with one aspect of the invention, a rotor lamination comprises: a circular laminar element comprising a plurality of openings configured to receive a plurality of rotor bars displaced circumferentially around the element, wherein the circular laminar element comprises a magnetic material, further wherein a first region of the circular laminar element having received a treatment, thereby rendering the first region such that a relative magnetic permeability of the first region is less than that of the magnetic material.

In accordance with another aspect of the invention, a method of manufacture comprises: selectively treating a region of a rotor lamination, thereby changing the magnetic permeability of the region, wherein the rotor lamination is configured for use in an electric machine, the rotor lamination comprises a plurality of openings displaced circumferentially around the rotor lamination, wherein the rotor lamination comprises a dual-phase magnetic material.

Various other features and advantages of the present invention will be made apparent from the following detailed description and the drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a front view of one embodiment of a rotor lamination for an induction machine of the related art.

FIG. 2 is a front view of another embodiment of a rotor lamination for an induction machine of the related art.

FIG. 3 is a front view of a rotor lamination for an induction machine in accordance with an embodiment of the present invention.

FIG. 4 is a close-up front view of a portion of the rotor lamination in FIG. 3 in accordance with an embodiment of the present invention.

FIGS. 5A-5E are close-up front views of a portion of different rotor lamination embodiments of the present invention.

FIG. 6 is a flowchart depicting a method of manufacture in accordance with an embodiment of the present invention.

### DETAILED DESCRIPTION

Unless defined otherwise, technical and scientific terms used herein have the same meaning as is commonly understood by one of ordinary skill in the art with respect to the presently disclosed subject matter. The terms “first”, “second”, and the like, as used herein do not denote any order, quantity, or importance, but rather are used to distinguish one element from another. The terms “a”, “an”, and “the” do not denote a limitation of quantity, but rather denote the presence of at least one of the referenced item, and the terms “front”, “back”, “bottom”, and/or “top”, unless otherwise noted, are used for convenience of description only, and are not limited to any one position or spatial orientation.

If ranges are disclosed, the endpoints of all ranges directed to the same component or property are inclusive and independently combinable (e.g., ranges of “up to about 25 wt. %,” is inclusive of the endpoints and all intermediate values of the ranges of “about 5 wt. % to about 25 wt. %,” etc.). The modified “about” used in connection with a quantity is inclusive of the stated value and has the meaning dictated by the context (e.g., includes the degree of error associated with measurement of the particular quantity). Accordingly, the value modified by the term “about” is not necessarily limited only to the precise value specified.

As used herein, “sensorless” means, for example, having a capability to operate without the need for sensors such as position or speed sensors.

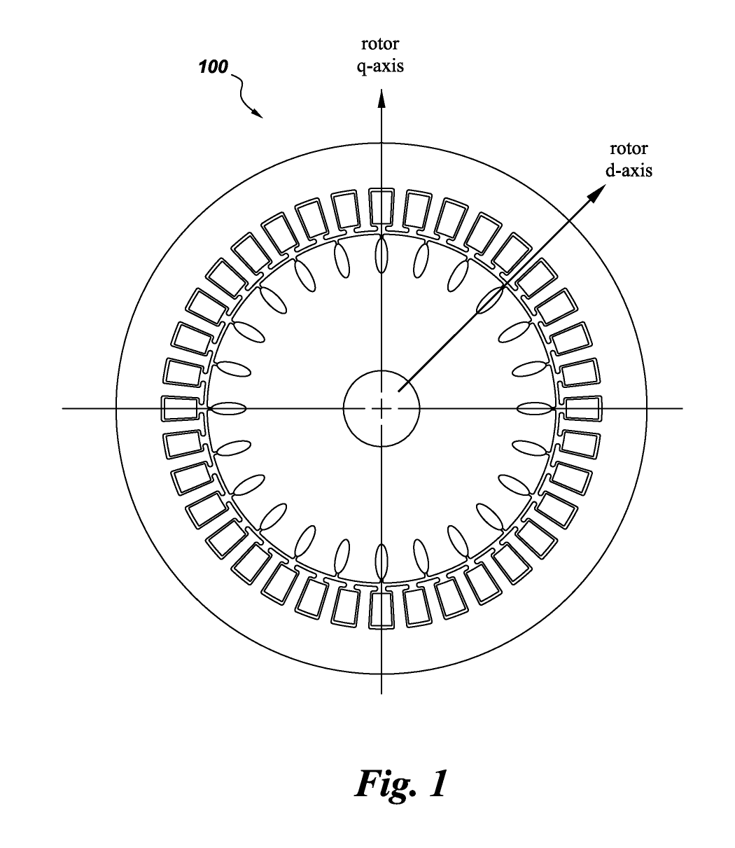

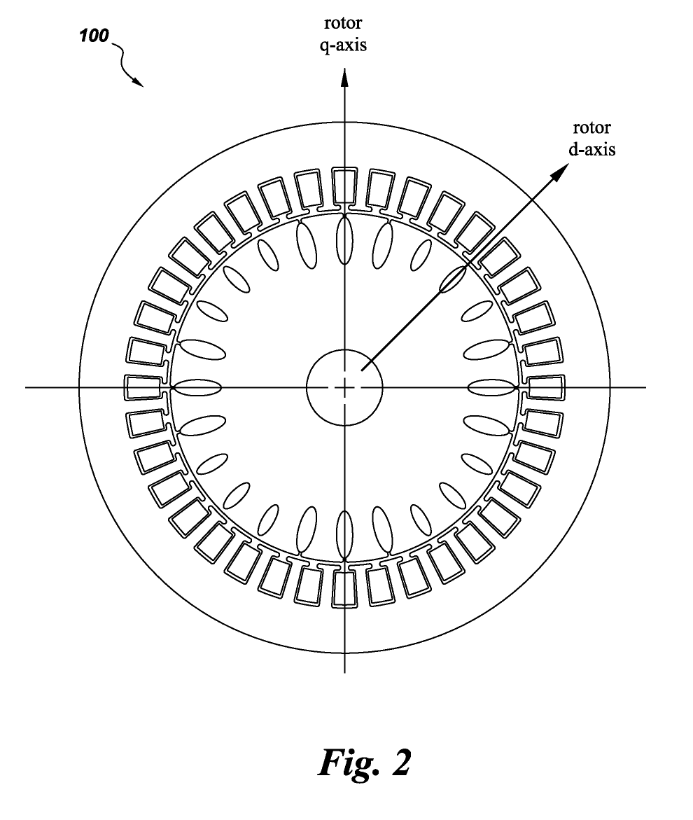

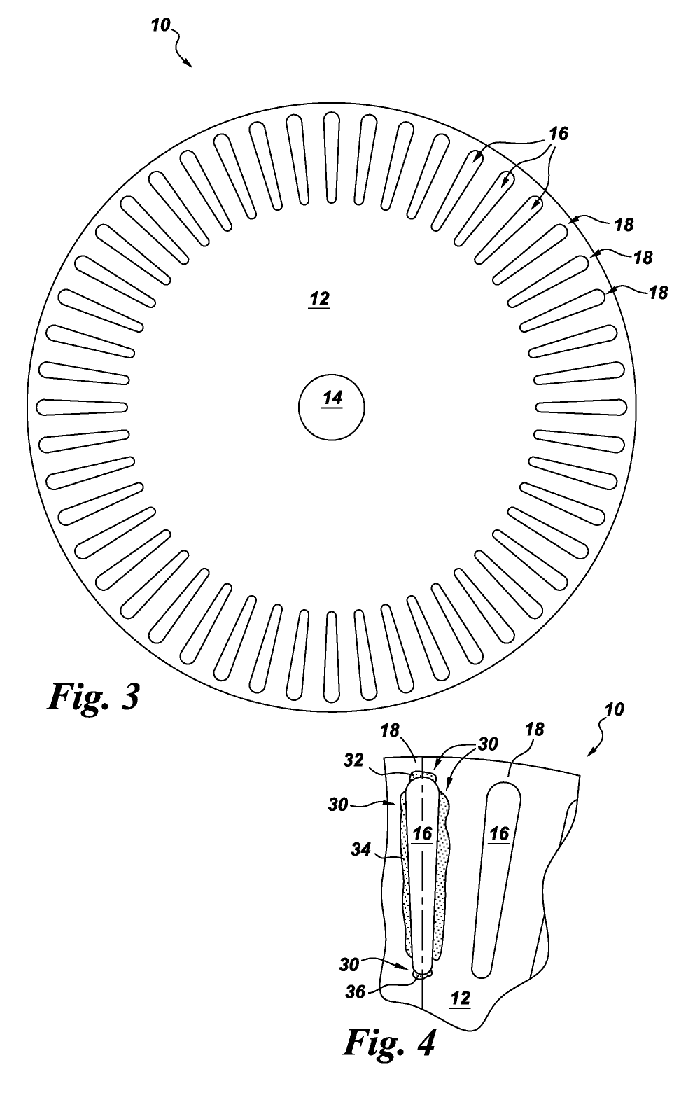

Aspects of the present invention have been shown to offer advantages over previous electrical machines. As shown, for example in FIG. 3, induction machines may have identical, smooth rotor bars so that there are no significant saliencies (variation of inductance as a function of rotor position). As such, it is difficult to use high-frequency signal injection signals from the stator side to trace the rotor saliencies to extract positional information and hence eliminate the need for position or speed sensors. Hence, providing a sensorless induction machine has proved difficult. However, aspects of the present invention applied to the lamination shown in FIG. 3, or other laminations, allow it to operate in an induction machine without the use of sensor(s), such as speed or position sensors. In fact, in other embodiments, aspect of the present invention may be applied to other laminations, including those displayed in FIGS. 1 and 2.

A front view of a rotor lamination, in accordance with aspects of the present invention, is depicted in FIG. 3. As shown, the rotor lamination 10 may comprise a circular laminar element 12 that includes a plurality of openings 16 that are circumferentially displaced around the element 12 and an axial opening 14 therethrough. The circular laminar element 12 may be comprised of any suitable dual-phase or bi-state magnetic material.

As depicted, the openings 16 are of uniform size, configuration, and shape around the element 12. Further, the openings 16 are configured to receive at each opening 16 a rotor bar (not shown). The openings 16 shown are closed. That is a bridge 18 of material is adjacent to the outer region of the opening 16 and the outer perimeter of the element 12, thereby defining the opening 16 to be closed.

In the embodiment shown, there are not slots on the periphery of the lamination 10. In other embodiments, there may be a plurality of slots on the periphery of the lamination 10 that align with each of the plurality of openings 16. The slots may be contiguous with the plurality of openings 16 such that the openings 16 are termed open. In other embodiments, the slots are not be contiguous with the plurality of openings 16 thereby defining the openings as still be termed closed, although the lamination is slotted.

At least a portion or region of the lamination 10 may be treated so that there is a resultant variation in the relative magnetic permeability between at least two regions of the lamination 10. Any suitable method for changing the magnetic permeability between at least two portions in the lamination 10 may be used. One suitable method that may be used for said treatment is disclosed in commonly assigned, pending U.S. patent application Ser. No. 14/068,937, entitled DUAL PHASE MAGNETIC MATERIAL COMPONENT AND METHOD OF FORMING (Attorney Docket no. 269697-1). The reference is incorporated herein in its entirety.

Referring to FIG. 4, a close-up front view of a portion of the rotor lamination 10 from FIG. 3 is depicted. At least one region 30 (i.e., first region) in the vicinity of the opening 16 is rendered less magnetic than the surrounding region, as a result of the treatment. The first region 30 may be selectively changed by local heat treatment, nitriding, or any other suitable method (e.g., as discussed above) that changes the first region 30 so that its relative magnetic permeability is less magnetic than the surrounding regions. In this manner, this selective treatment introduces rotor saliency by modulating the rotor bar leakage flux. Ultimately, an electric motor (e.g., induction machine) that uses the resultant rotor laminations 10 is more suitable for sensorless control.

As shown, one or more first regions 30 having a lower magnetic permeability than other regions of the lamination are achievable. For example, a first region 30 that is located in the bridge 18 area of the lamination 10 may receive treatment, is denoted as 32. Similarly, a first region 30 located in the vicinity of the sides of the opening 16 may receive treatment, is denoted as 34. Also, a first region 30 at the interior of the opening 16, distal from the bridge 18, may receive treatment, is denoted as 36.

It should be apparent that although three different first regions 30 of the lamination 10 are shown in FIG. 4 receiving treatment, other combinations are available. For example, treatment to reduce magnetism in a region 30 may be done in only one or two of the three first regions 30 discussed.

Additionally, the treatment will result in changing the relative magnetic permeability between at least two regions. In an embodiment, the treatment may result in a first region 30 being non-magnetic, as compared with the balance of the lamination 10 being magnetic. Similarly, depending on the application of the treatment to a first region 30, each individual region (e.g., 32, 34, 36) may have the same relative magnetic permeability to each other or the magnetic permeability may differ between the various first regions 30 around the opening 16. Additionally, the treatment may differ or be uniform around different openings 16 in the lamination.

That is, the treatment of every opening 16 of the lamination 10 may be the same, or it may differ depending on the opening 16.

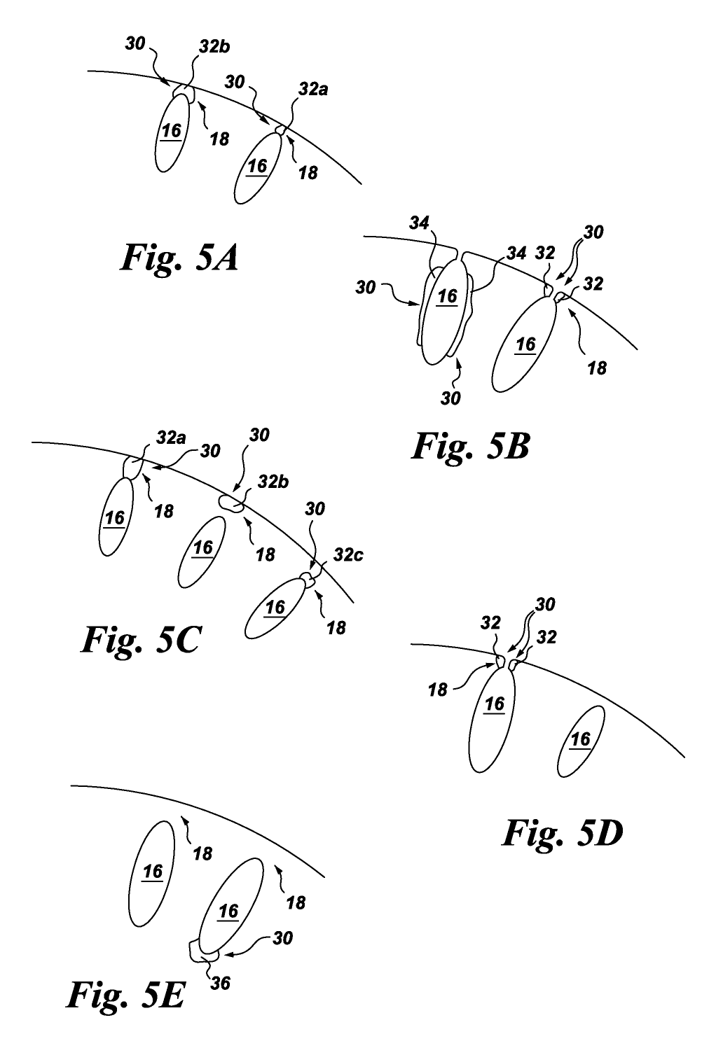

FIGS. 5A-5E depict close-up views of portions of laminations in other embodiments. As shown, the lamination that can use aspects of the present invention does not need to only be the embodiment shown in FIG. 3.

Referring to FIG. 5A, the treatment to the first region 30 may be only in the bridge area 18 of the opening 16, denoted by 32. Additionally, the treated bridge regions 32 may be such that the relative magnetism between the two bridge regions 32 differs such that the relative magnetic permeability between the bridge regions 32a, 32b, not only differ from the other regions, but differ from each other. As shown, for example, the treatment 32b in the bridge region 18 on the opening 16 on the left is wider than the treatment 32a in the bridge region 18 on the opening 16 shown on the right in FIG. 5A. As a result, the opening 16 on the left has lower leakage than the opening 16 on the right.

Referring to FIG. 5B, the lamination may have some openings 16 may be open to the edge of the lamination 10 while others are not. In the embodiment shown, both openings 16 are open to the slots on the edge, or periphery, of the lamination. The slotted, openopening 16 (on left of figure) may receive treatments in side regions 34. In the adjacent slotted, open opening 16 (on right of figure), the regions 30 receiving treatment may include the bridge region 32. Both openings 16 will have low leakage. Clearly, other configurations of treatment near the opening 16 are possible. For example, a treatment may be done to an opening combining both of the treatments shown in FIG. 5B.

Referring to FIG. 5C, the treated regions 30, in this case in the bridge region 32 may be located specifically in different locations in the bridge 18 of the openings 16. As shown, there are three different openings 16 each receiving treatment 32a, 32b, 32c in a different exact region of the bridge 18 of the lamination 10. The opening 16 depicted on the left, in the figure, receives treatment 32a across the full depth of the bridge region 18. Contrastingly, the opening 16 in the middle and on the right of the figure receives treatment 32b, 32c across only a portion (i.e., less than the full depth) of the bridge region 18. The opening 16 shown in the middle receives treatment 32b towards/adjacent the periphery, or edge, of the lamination in the bridge region 18. Contrastingly, the opening 16 shown on the right receives treatment 32b towards/adjacent to the opening 16 of the lamination in the bridge region 18.

Referring to FIG. 5D the lamination may have different size and type openings 16. For example, some openings 16 may be closed while others are open. Some laminations may include a slot on the periphery of the lamination. The slot may exist on an open opening or on a closed opening. In the embodiments shown, the slotted open opening 16 (on left of figure) may be receive treatment in the bridge regions 32. In the adjacent slotless and closed opening 16, there may be no treatment. The cross-sectional area may differ between openings 16. For example, the opening 16 on the left has a larger area than the opening 16 on the right.

Referring to FIG. 5E, the opening 16 on the right receives treatment in the region in the region distal to the bridge 36. This opening 16 has increased leakage as compared to the opening 16 on the left that receives not treatment.

The resultant rotor lamination 10 component may then be stacked on a rotor axis (not shown) so as to define a rotor core assembly. Surrounding this rotor core assembly may be a stator assembly. The resultant assembly comprises an electrical machine. The electrical machine may thus comprise an induction machine.

There are numerous pending and issued patents discussing the construction of stator assemblies, rotor assemblies, and/or electrical machines. One suitable method for assembly of such components is disclosed in commonly assigned, pending U.S. patent application Ser. No. 13/853,122, entitled DUAL MAGNETIC PHASE ROTOR LAMINATIONS FOR INDUCTION MACHINES (Attorney Docket no. 264829-1). The reference is incorporated herein in its entirety.

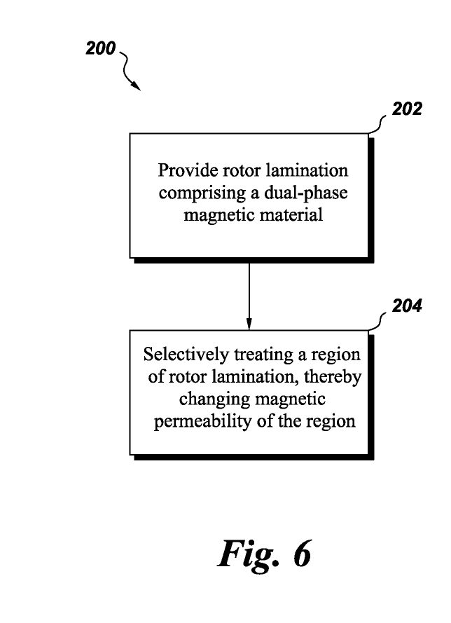

Referring to FIG. 6, a flowchart of an exemplary method of manufacture is depicted. The method 200 shown includes, optionally, at 202 providing a rotor lamination for use in an electric machine, wherein the rotor lamination comprises a plurality of openings circumferentially around the rotor lamination. The rotor lamination is comprised of a dual-phase magnetic material. At 204, a region of the rotor lamination is selectively treated, thereby changing a magnetic permeability of the region. In another embodiment, the method may comprise selectively treating a rotor lamination (i.e., 204) that is provided by another entity (i.e., a pre-existing rotor lamination).

While the embodiments illustrated and described herein may be used in an induction machine, the induction machine can likewise be used in virtually any suitable application such as a traction motor, and the like.

Therefore, in accordance with one aspect of the invention, a rotor lamination comprises: a circular laminar element comprising a plurality of openings configured to receive a plurality of rotor bars displaced circumferentially around the element, wherein the circular laminar element comprises a magnetic material, further wherein a first region of the circular laminar element having received a treatment, thereby rendering the first region such that a relative magnetic permeability of the first region is less than that of the magnetic material.

In accordance with another aspect of the invention, a method of manufacture comprises: selectively treating a region of a rotor lamination, thereby changing the magnetic permeability of the region, wherein the rotor lamination is configured for use in an electric machine, the rotor lamination comprises a plurality of openings displaced circumferentially around the rotor lamination, wherein the rotor lamination comprises a dual-phase magnetic material.

While only certain features of the invention have been illustrated and/or described herein, many modifications and changes will occur to those skilled in the art. Although individual embodiments are discussed, the present invention covers all combination of all of those embodiments. It is understood that the appended claims are intended to cover all such modification and changes as fall within the intent of the invention.

What is claimed is:

1. A rotor lamination comprising:
a circular laminar element comprising a plurality of openings configured to receive a plurality of rotor bars displaced circumferentially around the element, wherein the circular laminar element comprises a magnetic material, further wherein a first region of the circular laminar element having received a treatment, thereby rendering the first region such that a relative magnetic permeability of the first region is less than that of the magnetic material.

2. The rotor lamination of claim 1, wherein the magnetic material comprises a dual-phase magnetic material or bi-state magnetic material.

3. The rotor lamination of claim 1, wherein the rotor lamination is configured for use in an induction machine.

4. The rotor lamination of claim 1, wherein the plurality of openings has a uniform configuration.

5. The rotor lamination of claim 1, further comprising a plurality of slots on a periphery of the circular laminar element.

6. The rotor lamination of claim 5, wherein each of the plurality of slots is contiguous with one of the plurality of openings, thereby defining the plurality of openings as an open configuration.

7. The rotor lamination of claim 5, wherein each of the plurality of slots is not contiguous with one of the plurality of openings, thereby defining the plurality of openings as a closed configuration.

8. The rotor lamination of claim 1, wherein the first region is adjacent the plurality of openings.

9. The rotor lamination of claim 1, wherein the first region introduces rotor saliency by controlling the rotor bar leakage flux.

10. The rotor lamination of claim 1, wherein the first region is made by a local treatment of the magnetic material.

11. The rotor lamination of claim 8, wherein the local treatment comprises nitriding.

12. The rotor lamination of claim 1, wherein the first region is non-magnetic.

13. The rotor lamination of claim 1, wherein the first region of a first opening is different than the first region of a second opening.

14. The rotor lamination of claim 1, wherein the first region is located adjacent the opening in at least one of: a bridge region, a side region, and an end distal the bridge region.

15. An induction machine comprising:
a plurality of rotor laminations of claim 1 stacked, thereby defining a rotor core assembly; and
a stator surrounding the rotor core assembly.

16. The induction machine of claim 15, wherein the induction machine is encoderless.

17. A method of manufacture comprising:
selectively treating a region of a rotor lamination, thereby changing the magnetic permeability of the region, wherein the rotor lamination is configured for use in an electric machine, the rotor lamination comprises a plurality of openings displaced circumferentially around the rotor lamination, wherein the rotor lamination comprises a dual-phase magnetic material.

18. The method of claim 17, further comprising providing the rotor lamination.

19. The method of claim 17, the selectively treating comprises nitriding.

20. The method of claim 17, the selectively treating comprises applying a heat treatment.

21. The method of claim 17, the region adjoins the plurality of openings.

22. The method of claim 17, the plurality of openings configured to receive a rotor bar; and
the selectively treating comprises introducing rotor saliency by controlling the rotor bar leakage flux.
